(19) United States
(12) Patent Application Publication
(10) Pub. No.: US 2023/0267904 A1
(43) Pub. Date: Aug. 24, 2023

(54) Baffling system designed for acoustic suppression

(71) Applicant: Justin P. Manley, Katy, TX (US)

(72) Inventor: Justin P. Manley, Katy, TX (US)

(21) Appl. No.: 18/097,219

(22) Filed: Jan. 14, 2023

Related U.S. Application Data
(63) Continuation-in-part of application No. 15/670,080, filed on Aug. 7, 2017, now abandoned.

(51) Int. Cl. G10K 11/16

(52) U.S. Cl. CPC G10K 11/161; F04B 53/001

(57) ABSTRACT

A silencer device for acoustic suppression may include a first housing section; and a second housing section detachably connected to the first housing section. The first housing section may define a first baffle chamber and the second housing section defines a second baffle chamber. The silencer device may include a baffle device positioned within the first baffle chamber and the second baffle chamber.

### BACKGROUND

Reciprocating pumps utilize a suction manifold and a discharge manifold for moving the media that is being pumped. These manifolds are equipped with valves that assist the reciprocating pump in media delivery to the piston or plunger chamber. When the valves are opening and closing, this creates a high frequency energy wave that is contained in the pumped media. This high frequency energy wave is commonly referred to as acoustic energy or harmonics, and they are damaging to the pump and piping system. If acoustics aren’t properly filtered out of the system, this will create premature failures on pump expendables as well as the piping components.

### SUMMARY

A silencer device for acoustic suppression may include a first housing section; and a second housing section detachably connected to the first housing section. The first housing section may define a first baffle chamber and the second housing section defines a second baffle chamber. The silencer device may include a baffle device positioned within the first baffle chamber and the second baffle chamber.

The baffle device may include a first baffle.

The baffle device may include a second baffle in a spaced relationship to the first baffle.

The first baffle device may include a first arched aperture.

The first baffle device may include a second arched aperture.

The second baffle device may include a third arched aperture.

The second baffle device may include a fourth arched aperture.

The first arched aperture may be positioned substantially 90° from the third arched aperture.

The second arched aperture may be positioned substantially 90° from the fourth arched aperture.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates an end view of the silencer device of the present invention;

FIG. 2 illustrates a side view of the silencer device of the present invention;

FIG. 3 illustrates a top view of the silencer device of the present invention;

FIG. 4 illustrates a side view of the baffle device of the present invention;

FIG. 5 illustrates a front view of the first baffle of the present invention;

FIG. 6 illustrates a front view of the second baffle of the present invention;

FIG. 7 illustrates a side view of the first baffle or the second baffle of the present invention;

FIG. 8 illustrates a portion of the baffle chamber of the present invention;

FIG. 9 illustrates a side view of the baffle rod of the present invention;

FIG. 10 illustrates a side view of the groove;

FIG. 11 illustrates a system view of the present invention;

FIG. 12 illustrates an exploded view of the silencer device of the present invention.

### DETAILED DESCRIPTION

Reciprocating pumps utilize a suction manifold and a discharge manifold for moving the media that is being pumped. These manifolds are equipped with valves that assist the reciprocating pump in media delivery to the piston or plunger chamber. When the valves are opening and closing, this creates a high frequency energy wave that is contained in the pumped media. This high frequency energy wave is commonly referred to as acoustic energy or harmonics, and they are damaging to the pump and piping system. If acoustics aren’t properly filtered out of the system, this will create premature failures on pump expendables as well as the piping components. The present invention solves this problem.

The present invention utilizes an inline, multiple chambered, baffling system positioned between the suction manifold and the discharge manifold to absorb and reorganize high frequency energy waves or acoustic energy. The inline design forces the acoustics into the baffling chambers then restrict and redirects the flow of media, producing a pressure drop across the baffling and absorbing acoustic energy. The discharge of the baffling system produces a smoother, reorganized harmonic Signature safe for the pump and piping system.

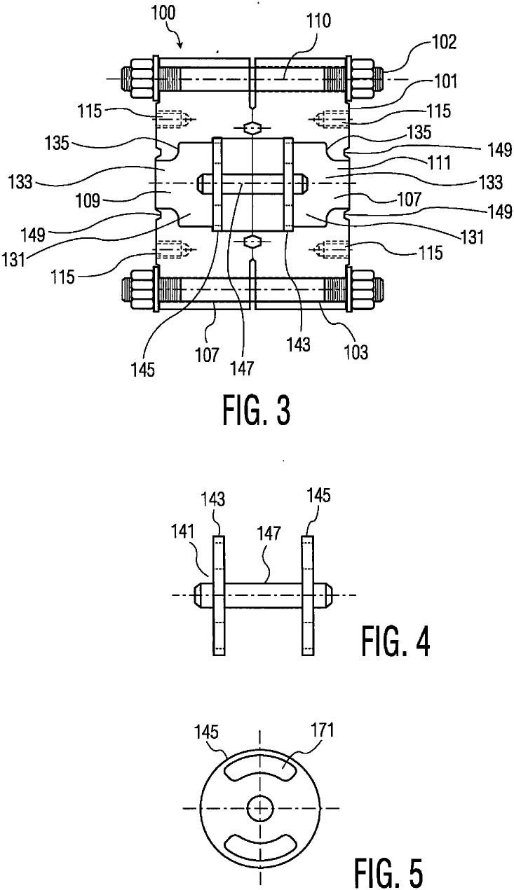

FIG. 3 illustrates a top view (which may be a mirrored bottom view) of the baffle housing 101 of the silencer device 100 of the present invention. The baffle housing 101 may include a first housing section 103 and a mirrored second housing section 105 which may be detachably connected to the first housing section 103 by a fastener 151 for example an opposed pair of threaded bolts and nuts or other appropriate fasteners. The first housing section 103 and the second housing section 105 may include a first baffle chamber 107 and a mirrored second baffle chamber 109 respectively which may extend through the baffle housing 101. The first baffle chamber 107 may extend through the first housing section 103 to the first opening 111, and the second baffle chamber 109 may extend through the second housing section 105 to the second opening 113 where the first opening 111 and the second opening 113 may connect to the suction manifold and the discharge manifold (not shown) respectively. The first baffle chamber 107 and the mirrored second baffle chamber 109 may include a wide portion 131 and a narrow portion 133 which may connect to the wide portion 131 and the first opening 111 and the second opening 113 and may connect to the wide portion 131 by a shoulder 135.

The wide portion 131 may be connected to a baffle device 141 which may include a pair of opposing first baffle 143 and a second baffle 145 which may be connected by a baffle connector rod 147. The periphery of the first baffle 143 and the second baffle 145 may extend to the surface of the first housing section 103 and the second housing section 105 respectively. The surface of the first housing section 103 and the second housing section may be defined by the wide portion 131 of the first baffle chamber 107 and the second baffle chamber 109.

The first housing section 103 and the second housing section 105 may include apertures 115 for connection to the suction manifold and to the discharge manifold. Additionally, the first housing section 103 and the second housing section 105 may include a groove 149 which may extend around the periphery of the first and second housing section 103, 105 in order to facilitate the application of a gasket to seal the suction manifold and the discharge manifold. FIG. 10 illustrates a detail of the groove 149.

FIG. 2 illustrates the first housing section 103 (the second housing section 105 may be a mirror of the first housing section 103) which may include the first baffle chamber 107 which may include a wide portion 131 and a narrow portion 133 connected by a shoulder 135. The narrow portion 133 may include an opening 111 to allow fluid to either enter or escape from or to the suction manifold/discharge manifold. A groove 149 may extend around the opening 111 to provide for a gasket to seal the housing section 103 with either the suction manifold or discharge manifold. A fastener 151 may extend through the first housing section 103 and the second housing section 105 to connect the first housing section 103 to the second housing section 105. These fasteners 151 may extend around the periphery of the silencer device 100.

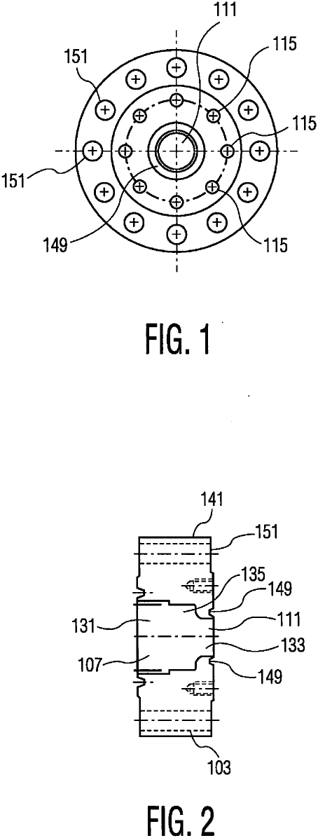

FIG. 1 illustrates an end view of the silencer device 100 of the present invention and illustrates the first housing section 103 which may include first opening 111 to the narrow portion 113 of the baffle chamber 107. Additionally illustrated is the aperture 115 the fastener 151 and the groove 149.

FIG. 4 illustrates a side view of the battle device 141 which may include a first baffle 141 and a second baffle 143 both of which may be positioned in a spaced relationship and may be mounted on a baffle connector rod 147 which may extend beyond the first baffle 141 and the second baffle 143. The baffle connector rod 147 is shown having a circular cross-section, but other configurations are within the scope of the present invention.

FIG. 5 illustrates an end view of the first baffle 145 which may include a first arched aperture 171 which may extend through the first baffle 145 and a second opposed arched aperture 173 which may extend through the first baffle 145. FIG. 5 shows that the first arched aperture 171 is positioned near the top of the first baffle while the second arched aperture 173 is positioned near the bottom of the first baffle 145.

FIG. 6 illustrates an end view of the second baffle 143 which may include a third arched aperture 175 and an opposed fourth arched aperture 177 both of which may extend through the second baffle 143. The third arched aperture 175 may be positioned along the side of the second baffle 143 (approximately 90° from the first arched aperture 171). The fourth arched aperture 177 may be positioned along the opposite side of the second baffle 143 (approximately 90° from the second arched aperture 173).

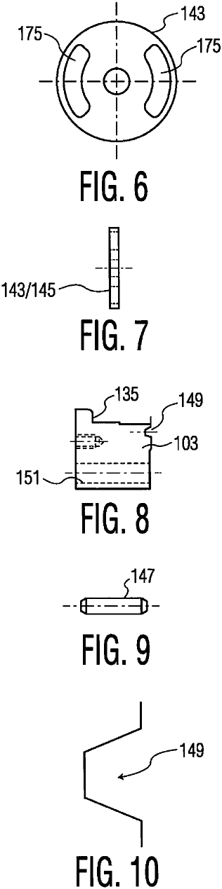

FIG. 7 illustrates a side view of either the first baffle 145 or the second baffle 143.

FIG. 8 illustrates a portion of the first housing section 103, the fastener 151, the groove 149 and the shoulder 135.

FIG. 9 illustrates a side view of the baffle connector rod 141.

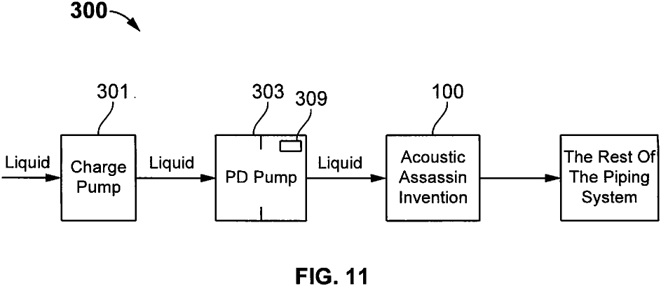

FIG. 11 illustrates a system diagram of the system 300 of the present invention. The system 300 may include a charge pump 301 which may receive a fluid such as a liquid into the charge pump 301. The charge pump 301 may be a centrifugal pump which is used to send the liquid to a reciprocating pump 303 and which may include a suction manifold 305 to draw in the liquid from the charge pump 301 and may include a discharge manifold 307 to discharge the liquid to the silencer device 100. The blades of the charge pump 301 creates turbulence and acoustics in the liquid which may be transferred to the suction manifold 305. This turbulence and acoustics may be detrimental and/or cause irrevocable harm to the remaining pipes and structure illustrated as element 311 In addition the reciprocal pump 303 which may be a PD (Positive Displacement) Pump may have between 3 and 5 (or greater or lessor) cylinders pushing liquid through the piping system of the reciprocating pump 303. The reciprocating pump 303 may include pump valves 309 which open and close and may cause additional turbulence and acoustics within the reciprocating pump 303. The liquid may be discharged from the reciprocating pump 303 by the discharge manifold 307. The liquid including turbulence and acoustic disturbances are transferred to the silencer device 100 that includes a series of orifices and chambers which de tunes the turbulence and acoustic especially reducing the high-frequency signatures. One example is described above.

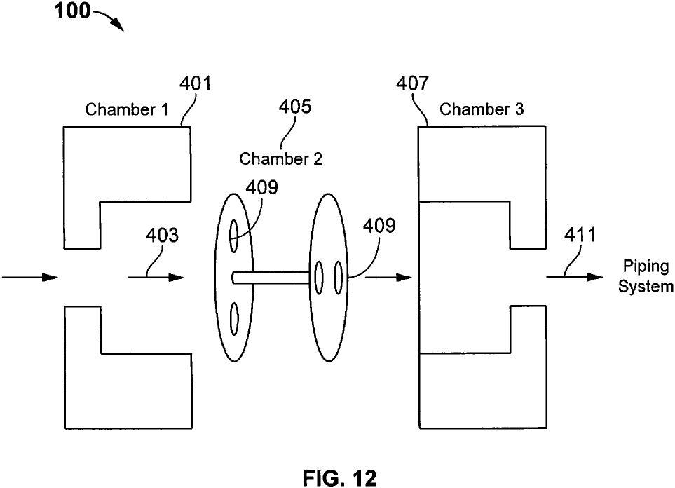

FIG. 12 illustrates an exploded view of the silencer device 100 and which illustrates a first chamber 401 having a first aperture 403 to receive the liquid from the reciprocating pump 303 and transfers the liquid to the second chamber 405 which may be a baffling system which transfers the liquid through a series of offsetting apertures 409 which transmits the liquid creating additional vena contracts and redirecting the liquid and acoustics through the second chamber 405 and the third chamber 407. The liquid is transferred to the third chamber 407 where the liquid is restricted to an output aperture 411 to the final vena contracts.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A system for acoustic generation and acoustic suppression of an acoustic wave in a liquid fluid, comprising:
a reciprocating pump having a suction manifold and a discharge manifold for moving the liquid fluid that is being pumped and configured to generate the acoustic wave in the liquid fluid,
a charge pump being directly connected to the suction manifold of the reciprocating pump,
a silencer device for the acoustic suppression of the acoustic wave in the liquid fluid and being directly connected to the discharge manifold of the reciprocating pump, the silencer device including:
a first housing section to accept the liquid fluid;
a second housing section detachably connected to the first housing section to discharge the liquid fluid;
wherein the first housing section defines a first baffle chamber to remove the acoustic wave from the liquid fluid and the second housing section defines a second baffle chamber to further remove the acoustic wave from the liquid fluid;
wherein the silencer device includes a baffle device positioned within the first baffle chamber and the second baffle chamber;
wherein the baffle device includes a first arched aperture to allow the liquid fluid to flow from the first baffle chamber to the second baffle chamber.

2) A silencer device for acoustic suppression as in claim 1, wherein the baffle device includes a first baffle.

3) A silencer device for acoustic suppression as in claim 2, wherein the baffle device includes a second baffle in a spaced relationship to the first baffle.

4) A silencer device for acoustic suppression as in claim 3, wherein the first baffle device includes a first arched aperture.

5) A silencer device for acoustic suppression as in claim 4, wherein the first baffle device includes a second arched aperture.

6) A silencer device for acoustic suppression as in claim 5, wherein the second baffle device includes a third arched aperture.

7) A silencer device for acoustic suppression as in claim 6, wherein the second baffle device includes a fourth arched aperture.

8) A silencer device for acoustic suppression as in claim 7, wherein the first arched aperture is positioned substantially 90° from the third arched aperture.

9) A silencer device for acoustic suppression as in claim 8, wherein the second arched aperture is positioned substantially 90° from the fourth arched aperture.
